(19) United States
(12) Patent Application Publication
(10) Pub. No.: US 2010/0161427 A1
(43) Pub. Date: Jun. 24, 2010

(54) Preview My Photo Processing System (PMPPS)

(76) Inventor: Chong Ng, Seattle, WA (US)

Correspondence Address: Jellett Law, PS;Matthew Jellett, Esq., 910 Harris Ave, Suite A205, BELLINGHAM, WA, 98225, US

(21) Appl. No.: 11/759,535

(22) Filed: Jun. 7, 2007

Related U.S. Application Data
(60) Provisional application No. 60/804,093, filed on Jun. 7, 2006.
(60) Provisional application No. 60/805,146, filed on Jun. 19, 2006.
(60) Provisional application No. 60/884,100, filed on Jan. 9, 2007.

(51) Int. Cl. G06Q 30/00; G09G 5/00; G06Q 50/00; G06Q 20/00; G06F 21/00

(52) U.S. Cl. 705/14.71; 345/620; 705/27; 345/441; 345/667; 726/3

(57) ABSTRACT

The present invention includes a method for bidding for a banner on a web site which includes the steps of bidding for the banner during a first period of time by a first bidder at a fixed price, bidding for the banner during a second period of time by the first bidder and a second bidder. The first bidder and the second bidder bid at different increments. The present invention additionally includes a method for previewing a photo processing system for displaying a first photo which includes the steps of logging in at a first login point by a customer, paying a preview fee before viewing the first photo, viewing the first photo, paying for the first photo, returning the preview fee after the first photo has been paid for.

### PRIORITY

The present invention claims priority under 35 USC section 119 based upon provisional application while on Jun. 7, 2006 with the Ser. No. 60/804,093, a provisional application filed on Jun. 19, 2006 with a Ser. No. 60/805,146, a provisional application filed on Oct. 31, 2006 with a Ser. No. 60/683,803 and a provisional application on Jan. 9, 2007 when a Ser. No. 60/884,100.

### FIELD OF THE INVENTION

The present invention relates to photo systems and two methods of paying for them.

### BACKGROUND OF THE INVENTION

Systems for taking photographs are known, and methods of paying for the photographs are additionally known.

### SUMMARY

The present invention includes a method for bidding for a banner on a web site which includes the steps of bidding for the banner during a first period of time by a first bidder at a fixed price, bidding for the banner during a second period of time by the first bidder and a second bidder. The first bidder and the second bidder bid at different increments.

If there is no second bidder, the first bidder can renew the banner at the rate of the first month.

If there are no bidders, the price of the banner drops by a fixed amount.

The present invention additionally includes a method for previewing a photo processing system for displaying a first photo which includes the steps of logging in at a first login point by a customer, paying a preview fee before viewing the first photo, viewing the first photo, paying for the first photo, returning the preview fee after the first photo has been paid for.

The method includes the step of event proving the first photo by the customer.

The method includes the step of cropping the first photo this by the customer.

The method includes the step of logging in to a second login point by a photographer.

The method includes the step of uploading a second photo.

The method includes the step of logging in at a third login point by an organization member to obtain organizational information.
1. Preview Fee required to unlock images, forfeit upon the end of the publishing date
2. Organization, for example, schools can monitor their “donation”, student id and yearbook photos.
3. Photographers, web hosting company and sales representative can now monitor their sales and commission online.
4. Banner Auction.

Feature
1. The image layer of the flooring should not occupy more than one third the space at the bottom of the image.
2. A pre-calibrated concentric circle or square is positioned at the vertical center of an image and just above its horizontal center to assist customer can place their face in the concentric circle or square to achieve specific length of head size required by government agency or schools.
3. Space compensation—if the picture does not completely fill a conventional size for example 4×6 ins, compensation may be added to the picture to prevent distortions if this picture was enlarged to meet the 4×6
4. The picture may be sized and cropped and may generate multiple pictures from a single picture.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a flow chart of the present invention;

FIG. 2 illustrates a background for insertion of customers;

FIG. 3 illustrates a altered background for insertion of customers;

FIG. 4 illustrates a picture of customers

FIG. 5 illustrates a picture of customers with the altered background;

FIG. 6 illustrates a picture of a customer with an overlying grid;

FIG. 7 illustrates a second flow chart of the present invention;

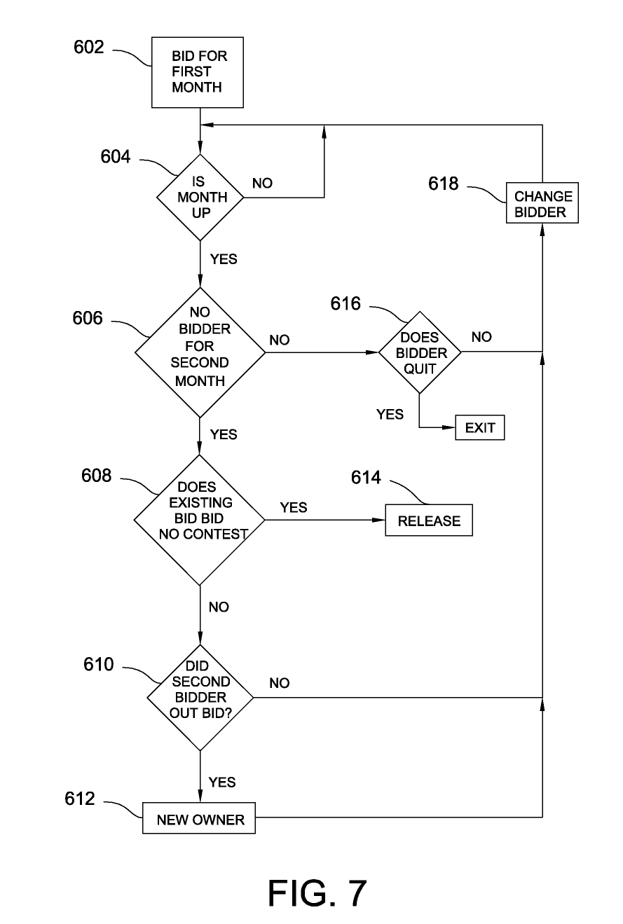

### DETAILED DESCRIPTION

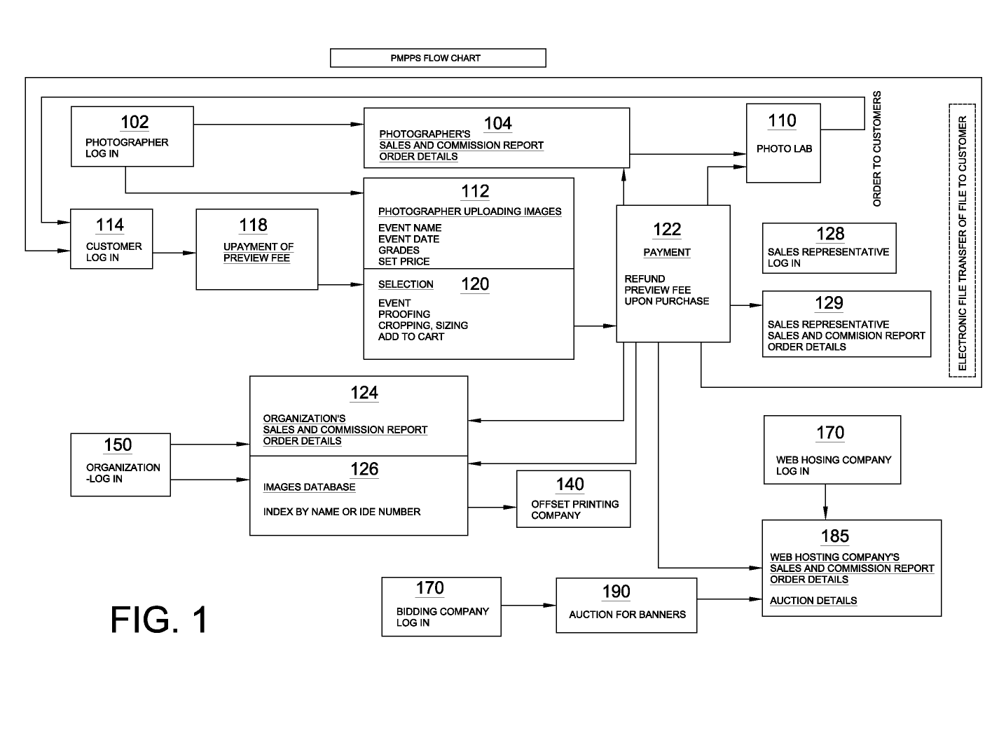

FIG. 1 illustrates a flow chart in accordance with the teachings of the present invention. FIG. 1 illustrates that there are several log in points for different types of users. FIG. 1 illustrates a first login point in step 102 for login by the professional photographer both the existing professional photographer who has been registered before and new professional photographers who has not been registered before. Photographer is hired by the organization in which pictures for example student pictures are desired in step 150 to performance the event. The photographer is to be reimbursed by percentage of sales or by a flat fee. In step 104, photographer can review their sales and commission report, and also order details. In step 112, both new and existing photographers can upload images of the event they have taken or created by creating a folder setting the event name, date, grades and pricing.

In step 114, a customer can login at a second login point. In step 118, customer pays a preview fee which is refunded after a purchase is made and forfeited if no purchases made. Here, the preview fee is paid to unlock their images. The photographer would have determined a publishing duration for the images, and once the publishing duration has expired, the preview fee is forfeited.

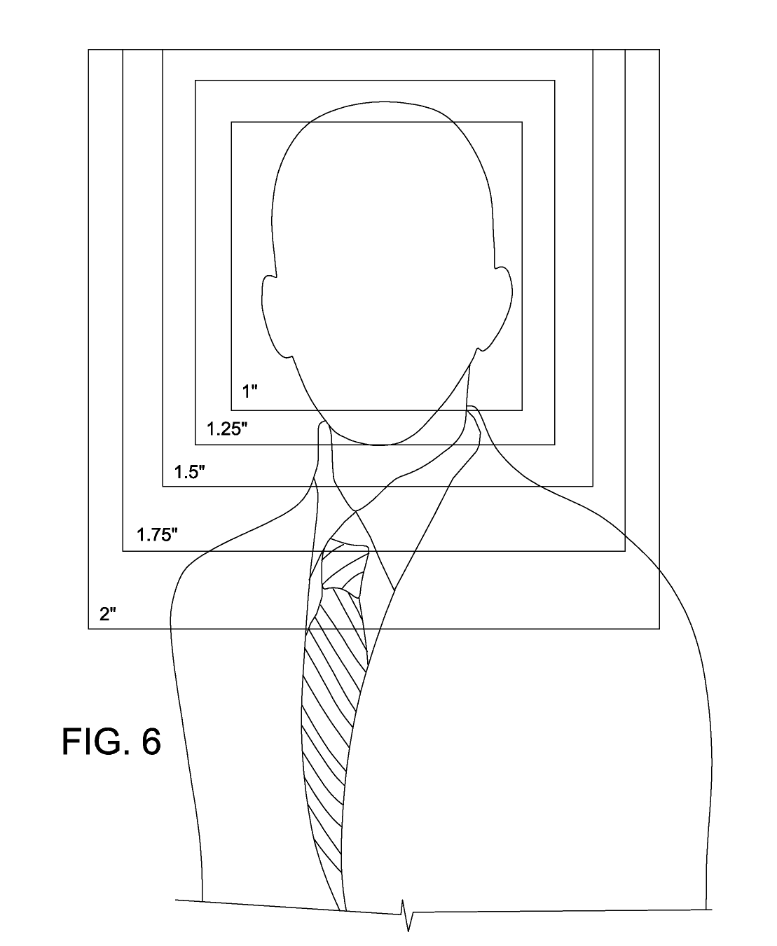

In step 120, the customer makes a selection based on the event, then proofs the picture, cropping and sizing with the aids shown in FIG. 6 if needed and adds the picture to the cart. The picture may be sized and cropped and may generate multiple pictures from a single picture. In the sizing and cropping stage, a pre-calibrated concentric circle or square is positioned at the vertical center of an image and just above its horizontal center. The customer can place a picture of their face in the precalibrated concentric circle or square to achieve specific length of head size required by government agency or schools. To achieve the specific head size, the hair of the subject should touch the top of the concentric circle or square and the chin to of the subject should touch the bottom of the concentric circle or square. Furthermore, if the picture does not completely fill a conventional size for example 4×6 ins, compensation may be added to the picture to prevent distortions if this picture was enlarged to meet the 4×6 conventional size. In a photograph, there are two elements: the subject and the background. When a photograph of a subject has a permanent background it is called a static background photograph. If the photograph of the subject can have an array of backgrounds to choose from, it is called a dynamic background photograph. The background and subject are independent of each other and are viewed as separate layers. The subject layer must appear as a clear layer, except for the actual area covered by the subject so that the background layer beneath is visible in the area around the subject.

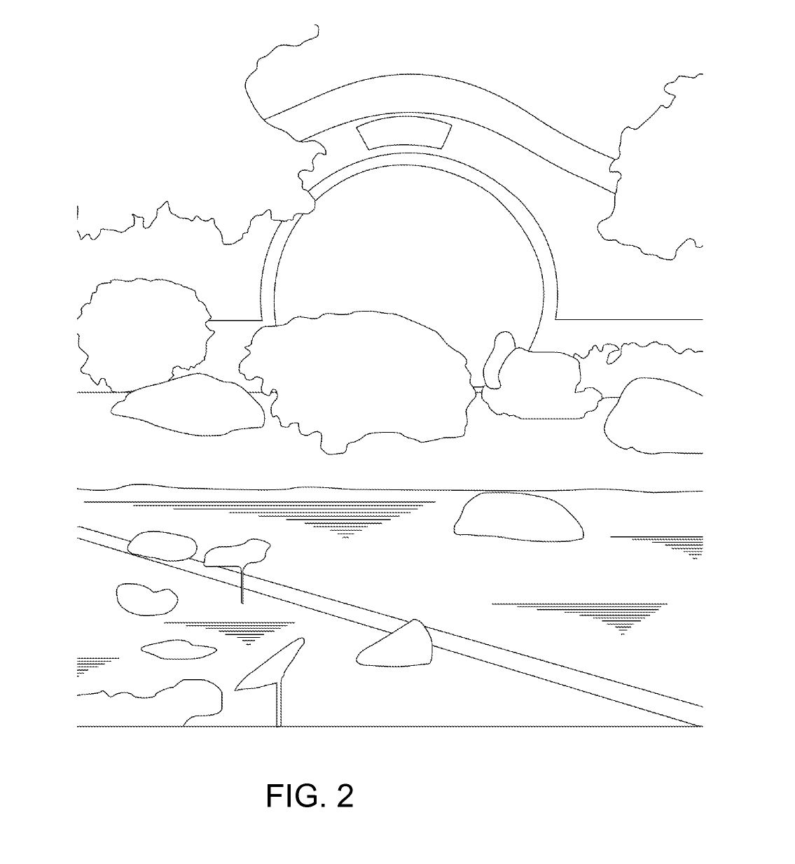

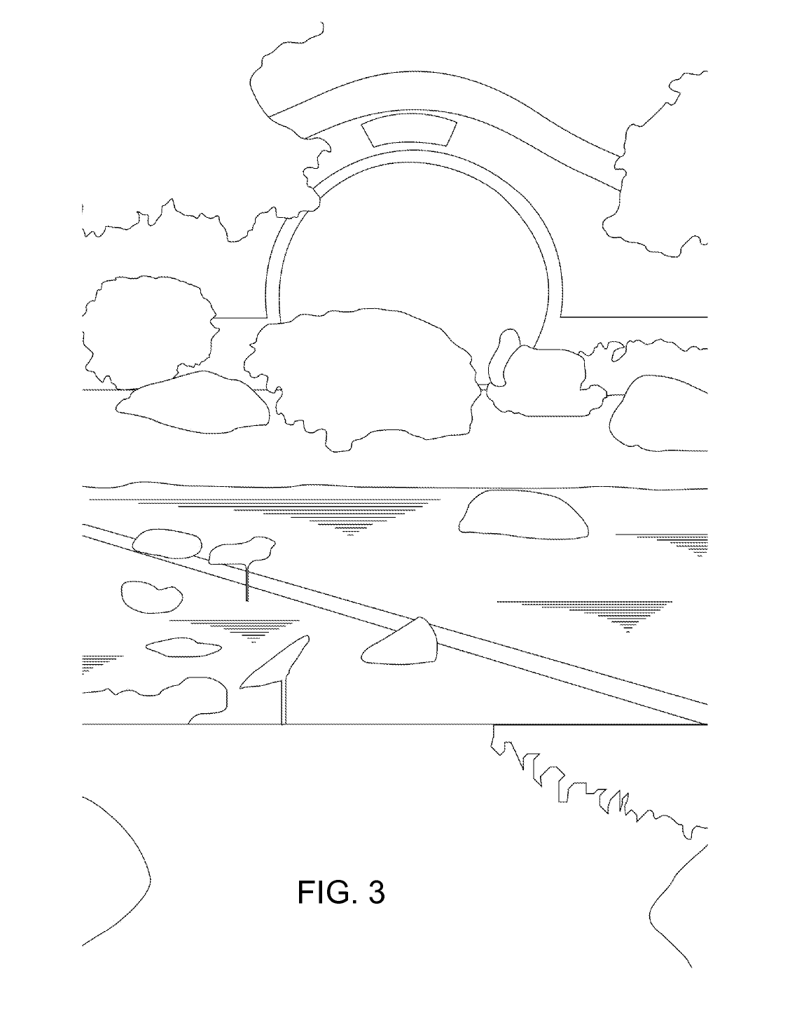

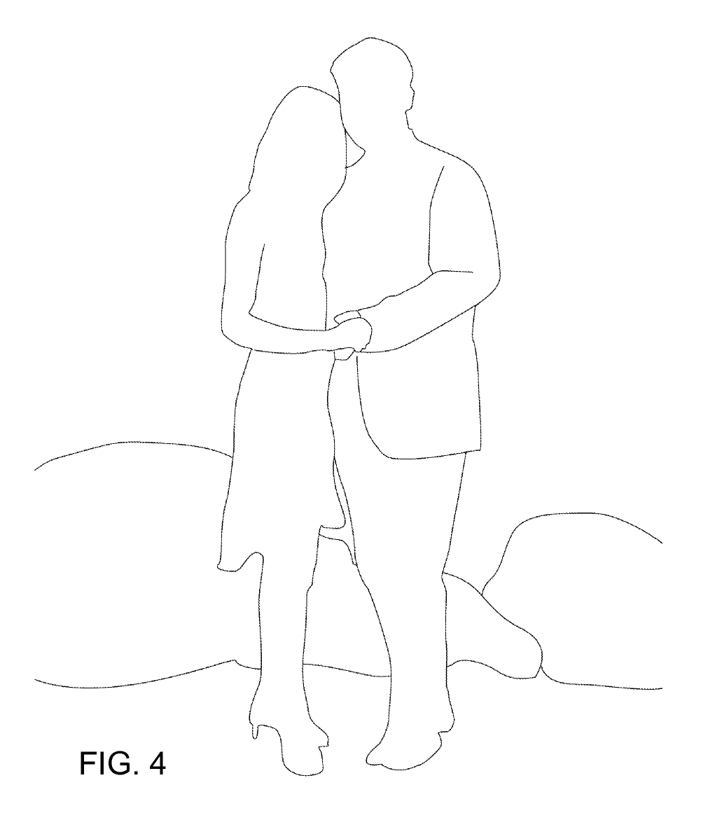

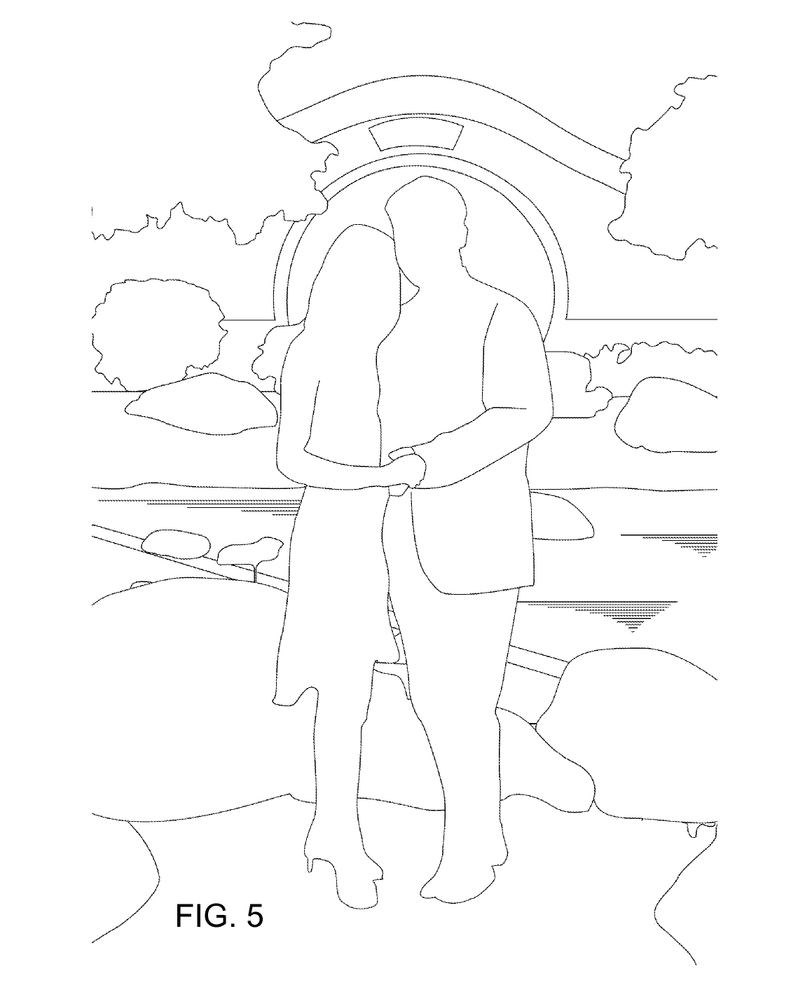

In reality, the background can consist of two independent layers—vertical backdrop (FIG. 2) and horizontal flooring on which the subject stands (FIG. 3). The image of the flooring should not occupy more than one third the space at the bottom of the image. This layer should lie on top of the backdrop layer. Customers will be able to select a custom combination of both flooring and backdrop, with the choices for each of these images stored in their respective databases. In the subject layer, FIG. 5 is uploaded in this layer and customer can position (enlarge/reduce) themselves base on the size print they have selected as shown in FIG. 6. FIG. 5 is the final assembly of FIGS. 2, 3 and 4.

In step 122, customer will finalize the order with preview fee credited back in full. A commission is also calculated by a percentage of the sales. This commission information is transferred to step 104, step 124, step 128 and step 170. Order details will be transferred to step 104 and step 110. Order information transfer from step 122 to step 104 usually requires photo enhancement. After completion of the enhancement, the image file will be transferred to step 110. In step 110, photo lab will process the order and ship out the order to the customer. The customer can also bypass the photo lab of step 110 by purchasing an electronic image file in step 122.

FIG. 1 illustrates a third login point 150 for organization such as the head of schools, the head of leagues and for the head of the corporation. In step 124 and step 126, organization will be able to view the sales and commission report, order details and image database of 126. Organization can transfer the images to an offset printer 140 from the database 126 when needed for printing.

In step 170, the web-hosting company logs in. Step 185 is where the web-hosting company can review all the sales and commission report, order details and sales from auction revenue. In step 170, is for company to login and is also where the bidding company will bid for their banner spot of the web hosting company web site. Here is a example.

PRODUCT=6 banners starting price each start at $X. Each banner is independent from the other banners.

CONTRACT=month to month basis. All sales are final and deposit is non refundable.

NEW BIDDER=must bid at least 10% more than existing bidder.

EXISTING BIDDER=must bid 5% more than new bidder's bid to stay in contract.

AUCTION DATE=First of the month to the 21^{st} of the month.

The first 6 advertisers will automatically be qualified for “one month” banner advertising contract after they have paid online in step 602. The advertiser has to upload the banner themselves when they are award the one month contract. The advertiser has the rights to the banner for one month in step 604

If there is no new bidder for the second month in step 606, existing bidder credit card will be charged automatically for $X. If there is a new bidder (new bidder must pay at least $X*1.1 to qualify), existing bidder will be notified by email every day till contract ends and existing bidder has two options: FIRST—no contest in step 608—existing bidder will be released from contract on the 30^{th} day. SECOND, existing bidder can hold the banner spot by out bid the new bidder by only 5% {($X*1.1)*1.05}. Existing bidder can be challenge ONCE per month.

In step 610 the bidding occurs. If new bidder is out bid by the existing bidder in step 612, they can also bit on the remaining 5 banner spots with the amount of non-refundable deposit they initially deposited. If the second bidding amount is greater than the first deposit, the new bidder has to pay the difference before challenging the second existing bidder.

When customer decides to quit after their one month contract in step 616 and also has no advertiser for the next month, the price of banner for that particular spot will drop by 25%.

In step 128, a last login point by the sales representative to view their sales and commission report and also order details in step 129.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A method for bidding for a banner on a web site, comprising the steps of:
bidding for the banner during a first period of time by a first bidder at a fixed price;
bidding for the banner during a second period of time by the first bidder and a second bidder:
wherein the first bidder and the second bidder bid at different increments.

2) A method for bidding for a banner on a web site as in claim 1, wherein if there is no second bidder, the first bidder can renew the banner at the rate of the first month.

3) A method for bidding for a banner on a web site as in claim 1, if there are no bidders, the price of the banner drops by a fixed amount.

4) A method for previewing a photo processing system for displaying a first photo, comprising:
logging in at a first login point by a customer;
paying a preview fee before viewing the first photo;
viewing the first photo;
paying for the first photo;
returning the preview fee after the first photo has been paid for.

5) A method for previewing a photo processing system for displaying a first photo as in claim 4, wherein the method includes the step of event proving the first photo by the customer.

6) A method for previewing a photo processing system for displaying a first photo as in claim 4, wherein the method includes the step of cropping the first photo this by the customer.

7) A method for previewing a photo processing system for displaying a first photo as in claim 4, wherein the method includes the step of logging in to a second login point by a photographer.

8) A method for previewing a photo processing system for displaying a first photo as in claim 7, wherein the method includes the step of uploading a second photo.

9) A method for previewing a photo processing system for displaying a first photo as in claim 4, wherein a method includes the step of logging in at a third login point by an organization member to obtain organizational information.

10) A method for previewing a photo processing system for displaying a first photo as in claim 4, wherein the method includes the step of cropping the first photo this by the customer and obtaining multiple images after the first photo is cropped.

11) A method for previewing a photo processing system for displaying a first photo as in claim 4, the method including the steps of forming a pre-calibrated circle and centering the pre-calibrated circle on a face of the first photo.

12) A method for previewing a photo processing system for displaying a first photo as in claim 4, the method including the steps of forming a pre-calibrated square in centering the pre-calibrated square on a face of the first photo.

13) A method for previewing a photo processing system for displaying a first photo as in claim 4, wherein the method includes the step of adding compensation to change an image size of the first photo to a print size.
